(19) United States
(12) Patent Application Publication
(10) Pub. No.: US 2022/0227347 A1
(43) Pub. Date: Jul. 21, 2022

(54) COUPLING ARRANGEMENT FOR A HYDRAULIC DEIVE, AND METHOD FOR COUPLING AND FLUIDICALLY CONNECTING FIRST AND SECOND COUPLING COMPONENT OF THE COUPLING ARRANGEMENT

(71) Applicant: Schaeffler Technologies AG & Co. KG, Herzogenaurach (DE)

(72) Inventors: Alexis GALANT, Saran (FR); Stephane ROCQUET, Sandillon (FR); Julien DURR, Fleury les Aubrais (FR)

(73) Assignee: Schaeffler Technologies AG & Co. KG, Herzogenaurach (DE)

(21) Appl. No.: 17/615,619

(22) PCT Filed: Apr. 1, 2020
(86) PCT No.: PCT/DE2020/100271

§ 371 Date: Dec. 1, 2021

(30) Foreign Application Priority Data
Jun. 5, 2019 (DE) 10 2019 115 109.0
Jun. 18, 2019 (DE) 10 2019 116 439.7

(51) Int. Cl. B60T 17/04; B62L 3/02; F16L 37/34; F16L 37/35

(52) U.S. Cl. CPC B60T 17/043; B62L 3/023; B60T 11/323; F16L 37/35; F16L 37/34

(57) ABSTRACT

A coupling arrangement for a hydraulic device, in particular for a brake hose of a hydraulic brake of a vehicle. The coupling arrangement includes first and second coupling components, and the first and second coupling components can be transferred from an uncoupled state into a coupled state. The first coupling component has a hydraulic chamber which is prefilled with a first hydraulic liquid, and the second coupling component has a hydraulic cylinder which is prefilled with a second hydraulic liquid. The hydraulic chamber and the hydraulic cylinder are fluidically connected to one another in the coupled, a first flow opening is incorporated in the hydraulic chamber, and the first coupling component has a first sealing device which closes the first flow opening in a flow-tight manner in the uncoupled state and frees it in the coupled state.

### CROSS-REFERENCE TO RELATED APPLICATIONS

This application is the U.S. National Phase of PCT Appln. No. PCT/DE2020/100271, filed Apr. 1, 2020, which claims priority from German Patent Application No. 10 2019 115 109.0, filed Jun. 5, 2019, and German Patent Application No. 10 2019 116 439.7, filed Jun. 18, 2019, the entire disclosures of which are incorporated by reference herein.

### TECHNICAL FIELD

The disclosure relates to a coupling arrangement for a hydraulic device, in particular for a brake hose device of a hydraulic brake of a vehicle. The coupling arrangement comprises a first coupling component and a second coupling component, wherein the first coupling component and the second coupling component can be transferred from an uncoupled state into a coupled state. The first coupling component has a hydraulic chamber prefilled with a first hydraulic liquid, and the second coupling component has a hydraulic cylinder prefilled with a second hydraulic liquid. The hydraulic chamber and the hydraulic cylinder are fluidically connected to one another in the coupled state of the first coupling component and the second coupling component. A first flow opening is incorporated in the hydraulic chamber. The disclosure further relates to a method for coupling and fluidically connecting a first coupling component and a second coupling component of the coupling arrangement.

### BACKGROUND

If two hydraulic cylinders prefilled with a liquid are to be connected together to form part of a braking system for a vehicle, e.g., for a two-wheeler, it is necessary for the two hydraulic cylinders to be sealed before assembly so that the filled in liquid cannot leak out. In addition, precautions must be taken to ensure that no air is trapped in the hydraulic cylinders during assembly. The two fully assembled hydraulic cylinders should then ensure unobstructed flow of the liquid between the hydraulic cylinders.

A hydraulic bicycle brake with prefilled hydraulic cylinders that are fluidically connected to one another is described, for example, in US 2016/0200392 A1. Document US 2018/0229703 A1 describes a self-sealing hydraulic device for bicycles in which two hydraulic cylinders are bolted together and sealed using ring seals.

### SUMMARY

The disclosure is based on the object of providing a coupling arrangement for a hydraulic device, the coupling components of which can be coupled in a functionally simple and safe manner to form a flow connection. This object is achieved by a coupling arrangement for a hydraulic device with one or more of the features disclosed herein and by a method for coupling and fluidically connecting a first coupling component and a second coupling component of a coupling arrangement with one or more of the features of disclosed herein. Preferred or advantageous embodiments result from the following description, claims, and/or the attached figures.

What is provided is a coupling arrangement for a hydraulic device, in particular for a brake hose device of a hydraulic brake of a vehicle. Preferably, the vehicle is designed as a small or micro vehicle or as an electric vehicle. The vehicle preferably has at least one wheel. With only one wheel, the vehicle can be designed as an electric unicycle, e.g., a so-called monowheel or solowheel. With two or more wheels, the vehicle is preferably designed as a scooter, in particular as an electric motorcycle, as an electric motor scooter, as an electric scooter, electric pedal-scooter, e.g., e-scooter, as a Segway, hoverboard, kickboard, skateboard, longboard or the like. Alternatively, the vehicle can be designed as a bicycle, in particular as an electric bicycle, for example as a pedelec or as an e-bike. The vehicle can alternatively be designed as a multi-track bicycle, in particular with three or more wheels. For example, the vehicle may be a transport or cargo bike, in particular a motorized or electrically powered transport or cargo bike, more specifically a three-wheeled or four-wheeled pedelec or a rickshaw, in particular with or without a roof, or a cabin scooter.

The coupling arrangement comprises a first coupling component and a second coupling component. The first coupling component and the second coupling component can be transferred from an uncoupled state to a coupled state. In particular, the two coupling components, hereinafter referred to as the first and second coupling components, can be coupled together to form a coupling unit. In particular, the two coupled components can be decoupled from one other again without causing damage. For example, the two components can be disposed between a vehicle brake arranged on the wheel side and a brake actuating device of the vehicle arranged on the handlebar side, e.g., a hand lever.

The first component comprises a hydraulic chamber. Preferably, the hydraulic chamber is cylindrical in shape. Optionally, one axial end of the hydraulic chamber is closed and another opposite end is connected to a first hose section sealed at the end. The hydraulic chamber and optionally in addition the first hose section is/are prefilled with a first hydraulic liquid. It is particularly preferred that the first component is completely sealed flow-tight to the outside in the uncoupled state so that the hydraulic liquid cannot leak and/or so that no air can be trapped in the hydraulic chamber.

The second component comprises a hydraulic cylinder. Preferably, the hydraulic cylinder is connected at one axial end to a second hose section sealed at the end. An insertion opening for inserting a section of the hydraulic chamber is preferably provided at another opposite end. The hydraulic cylinder and optionally in addition the second hose section is/are prefilled with a second hydraulic liquid. It is particularly preferred that the second component is completely sealed flow-tight to the outside in the uncoupled state so that the hydraulic liquid cannot leak and/or so that no air can be trapped in the hydraulic cylinder.

In the coupled state of the components, the hydraulic chamber and the hydraulic cylinder are fluidically connected to one another. In particular, both hydraulic liquids can flow from one component to the other and/or be mutually exchanged and/or mixed with one another.

A first flow opening is incorporated in the hydraulic chamber of the first component. The first flow opening is preferably provided to enable the flow connection between the two components. For example, the first flow opening is an opening running radially at least in sections in an outer side of the hydraulic chamber. Optionally, the first flow opening is disposed in a portion of the hydraulic chamber adjoining the closed axial end of the hydraulic chamber. Optionally in addition, the second component comprises a second flow opening.

The first component comprises a first sealing device. According to the disclosure, the first flow opening is flow-tightly closed by the first sealing device in the uncoupled state of the components. In particular, the first sealing device seals the first flow opening against an outflow of the liquid when the components are in the uncoupled state. This is advantageous because the first component is thereby flow-tightly sealed prior to coupling with the second component, e.g., during transport, storage and/or handling, and thus the functionality of the first component is fully preserved after coupling with the second component.

According to the disclosure, the first sealing device further frees the first flow opening in the coupled state of the components so that a fluidic connection of the two components is ensured and/or formed in the coupled state. In particular, the first flow opening is uncovered and unsealed by the first sealing device in the coupled state. This can advantageously ensure that the first hydraulic liquid can flow out of the hydraulic chamber through the first flow opening and/or that the second hydraulic liquid can flow into the hydraulic chamber through the first flow opening.

In a preferred embodiment, the first sealing device is annular, particularly in the form of a sealing ring. Preferably, the first sealing device is seated externally on the hydraulic chamber, being arranged in a first position on the hydraulic chamber, in particular in the uncoupled state. In particular, the first sealing device encloses the hydraulic chamber in the uncoupled state in the first position. The first position is preferably where the first flow opening is incorporated in the hydraulic chamber. Particularly preferably, the first sealing device covers and seals the first flow opening in the first position when the two components are in the uncoupled state.

In further preferred embodiment, the first sealing device sits externally on the hydraulic chamber in a second position when the components are in the coupled state. For example, the second position can be different and spaced apart from the first position. Optionally, the second position can be arranged in a portion of the hydraulic chamber adjacent to the axial end where the first hose section is located. Preferably, the first sealing device encloses the hydraulic chamber in the coupled state in the second position. Preferably, the first flow opening is uncovered by the first sealing device when the first sealing device is in the second position. In particular, the first flow opening is free and thus open for the flow of hydraulic liquids when the first sealing device assumes the second position.

In a possible further development, the first component comprises a first piston. For example, the first piston is annular in an axial plan view, the piston preferably having an annular piston surface and a circumferential rim projecting axially from the piston surface and enclosing a receiving space together with the piston surface. It is particularly preferred that the first sealing device is arranged in the receiving space of the piston.

In one possible constructive implementation, the piston, preferably together with the first sealing device, sits on and/or surrounds the hydraulic chamber. Preferably, the piston is arranged to be axially movable on the hydraulic chamber. In particular, the first piston is axially displaceable along the hydraulic chamber, wherein the first sealing device accommodated in the receiving space is in particular displaceable together with the piston. Thus, the first sealing device can be transferred from the first position to the second position, which occurs in particular when and/or while the two components are coupled.

In another possible constructive embodiment, the first coupling component comprises a sleeve. Preferably, the sleeve is arranged concentrically to the first piston and/or to the hydraulic chamber. In particular, the sleeve surrounds the first piston at least in sections when the two components are in the uncoupled state and/or when the first sealing device is arranged in the first position. It is particularly preferred in the context of the disclosure that the first piston is moved away from and/or out of the sleeve and/or spaced apart from the sleeve in the coupled state of the two components.

In a possible further development, the first coupling component comprises a first spring device, which is configured, for example, as a helical compression spring. Optionally, the spring device encompasses the hydraulic chamber. Preferably, the first piston is elastically mounted on the first spring device. In particular, in the uncoupled state of the two components, the first piston is spring-loaded at least in sections into the sleeve and/or held in the sleeve.

It is particularly preferred that the sleeve has an annular or partially annular clip that applies radial pressure on the first piston and optionally in addition on the first sealing device when the first piston is at least partially surrounded by the sleeve. In particular, the first sealing device is pressed onto the first flow opening by the applied radial pressure. Thus, the first sealing device is advantageously secured against detachment from the first flow opening. For this purpose, the sleeve serves in particular as a securing device for the first sealing device when the two components are uncoupled. This is of great advantage because the first component is flow-tight and the hydraulic liquid cannot leak out even during transport, storage and retrieval, handling and, naturally, during and/or in the course of assembly. Furthermore, the first sealing device and the sleeve as a safety device can prevent air from being trapped in the hydraulic chamber before, during and/or in the course of assembly.

In a preferred embodiment, the first coupling component has a coupling housing that is cylindrical and open on both axial sides. Preferably, the coupling housing has a receiving section and a coupling section. In particular, the first spring device, the first piston and the sleeve are completely received in the receiving section. In particular, the hydraulic chamber is received at least in sections in the receiving section. For example, the hydraulic chamber is connected to the receiving section in a form-fitting or force-fitting manner. Optionally, the hydraulic chamber protrudes from the receiving section and/or from a side of the coupling housing with the axial end where the first hose section is arranged.

Preferably, the coupling section is unoccupied in the uncoupled state of the two components. Optionally, the coupling section has an internal thread, particularly for coupling with the second component. Specifically, in the coupled state of the two components, the coupling section is occupied by a section of the second component. In particular, the hydraulic cylinder is for this purpose inserted in sections, in particular for the most part or in its entirety, into the other side of the coupling housing and/or into the coupling section.

In a possible constructive implementation, the hydraulic cylinder of the second component has a coupling mating section. The coupling mating section preferably has an external thread for screwing to the internal thread in the coupling section of the first component. In particular, the internal thread and the external thread are placed against one another for mutual screwing when the hydraulic cylinder is in sections, for the most part or in its entirety inserted into the coupling housing of the first component. In this arrangement, the hydraulic cylinder is inserted into and/or partially pushed through the sleeve so that the sleeve surrounds the hydraulic cylinder in this arrangement. In particular, the first piston and the first spring device are pushed out of the sleeve in this arrangement. The two components can be coupled by screwing the internal thread and the external thread to one another to form a coupling unit. In particular, the hydraulic chamber and the hydraulic cylinder are fluidically connected to one another in the coupling unit.

In a preferred embodiment, the second component comprises a second piston, a second spring device and a second sealing device. For example, the second sealing device can be configured as a sealing ring. For example, the second spring device can be configured as a helical compression spring. Preferably, the second piston is arranged to be axially movable in the hydraulic cylinder. In particular, the second piston is elastically mounted in the hydraulic cylinder on the second spring device for this purpose.

It is particularly preferred that a second flow opening is incorporated in the second piston, through which the second hydraulic liquid can flow and optionally also the first hydraulic liquid, in particular in the coupled state of the two components.

Preferably, the insertion opening of the hydraulic cylinder is, for example, closed in a form-fitting manner in the uncoupled state by the second piston, whereby it is pressed into the insertion opening under spring force in particular for this purpose. In particular, in the uncoupled state of the two components, the second piston assumes a closed position when it is pressed into and/or closes the insertion opening. The insertion opening closed by the second piston is preferably fluidically sealed by the second sealing device. For this purpose, the second sealing device is seated on and/or surrounds the second piston in a form-fitting manner.

In another preferred implementation, the second piston is axially displaced out of the closed position in the coupled state of the two components, in particular against the spring force of the second spring device. This frees the insertion opening from the second piston.

A preferred constructive embodiment provides that, in the coupled state of the two components, a section of the first component is inserted through the insertion opening. Preferably, the portion of the hydraulic chamber in which the first flow opening is incorporated protrudes through the insertion opening when the two components are in the coupled state. In particular, in the coupled state, the hydraulic cylinder is inserted through the axial opening in the hydraulic chamber so that it is received at least in sections in the receiving section of the coupling housing. Optionally in addition, the portion of the hydraulic chamber in which the first flow opening is incorporated is arranged in the hydraulic cylinder when the two components are coupled together to form the coupling unit. This ensures that the first flow opening and the second flow opening are arranged inside the hydraulic cylinder and that the flow connection between the two components, in particular between the hydraulic cylinder and the hydraulic chamber, is thereby formed.

A further object of the disclosure is a method for coupling and fluidically connecting a first coupling component and a second coupling component of a coupling arrangement according to the disclosure.

As part of the method, the second component is inserted into the first component in sections. During insertion, the first sealing device is moved out of the first position in which it seals the first flow opening so that it frees the first flow opening to form the fluidic connection.

In a preferred method step, the hydraulic cylinder is inserted at least in sections into the coupling housing and screwed to it. During insertion of the hydraulic cylinder into the coupling housing, the hydraulic cylinder pushes the first piston with the first sealing device arranged in the receiving space out of the sleeve and/or axially along the hydraulic chamber, in particular against the spring force of the first spring device. In the process, the hydraulic cylinder is inserted into the sleeve or partially inserted through it.

During insertion of the hydraulic cylinder into the coupling housing or screwing of the hydraulic cylinder to the coupling housing, the portion of the hydraulic chamber in which the first flow opening is incorporated is pushed through the insertion opening of the hydraulic cylinder, thereby pushing the second piston out of the closed position, in particular against the spring force of the second spring device, and displacing it axially in the hydraulic cylinder. As a result, both flow openings are arranged in the hydraulic cylinder so that a flow connection is formed between the two components through which the hydraulic liquids can be exchanged between the two components coupled to the coupling unit.

### BRIEF DESCRIPTION OF THE DRAWINGS

Further features, advantages and effects of the disclosure are set out in the following description of the preferred embodiments of the disclosure. In the figures:

FIG. 1 shows a first coupling component of a coupling arrangement;

FIG. 2 shows a second coupling component of a coupling arrangement;

FIG. 3A shows an axial section view of the first coupling component;

FIG. 3B shows a perspective axial top view of the first coupling component;

FIG. 4 shows an axial section view of the second coupling component; and

FIGS. 5A-5D show the method steps for coupling and fluidically connecting the first and second coupling components.

### DETAILED DESCRIPTION

Parts that correspond to each other or are identical are marked with the same reference marks in the illustrations.

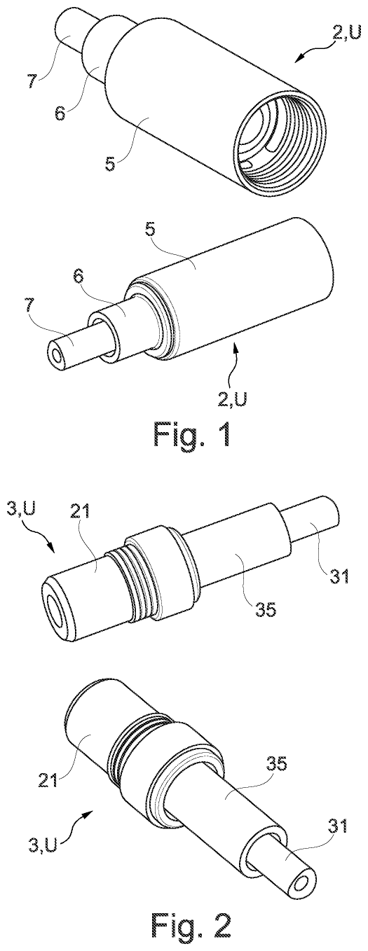

FIG. 1 shows a first coupling component 2 of a coupling arrangement 1 in two different perspective views. FIG. 2 shows a second coupling component 3 of the coupling arrangement 1 also in two different perspective views.

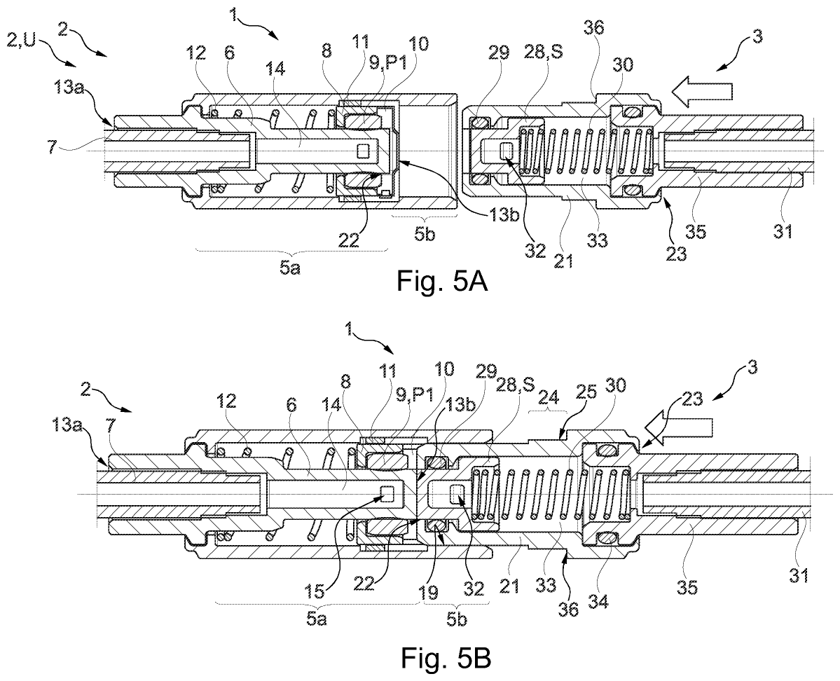

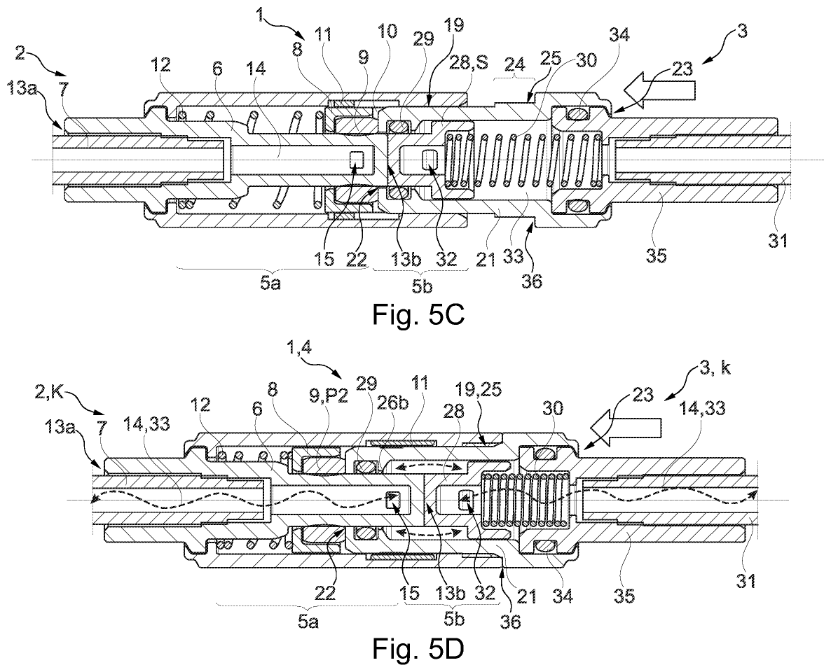

The coupling arrangement 1, which can be seen in FIGS. 5A to 5D, is designed to be integrated in a hydraulic device. In particular, the coupling arrangement 1 may form part of the hydraulic device. The hydraulic device can, for example, be designed as or comprise a brake hose device for a hydraulic brake of a vehicle, e.g., a two-wheeler, in particular a bicycle, e-scooter, electric scooter or electric pedal-scooter. In particular, the coupling arrangement 1 can be arranged between the hydraulic brake and a brake actuating device, for example a hand lever on a handlebar of the vehicle.

The first coupling component 2 and the second coupling component 3, hereinafter referred to as the first and second components 2, 3, can be coupled together to form a coupling unit 4 shown in FIG. 5D.

In FIGS. 1 to 4 and 5A, the components 2, 3 are shown in an uncoupled state U. When coupled together to form the coupling unit 4, they are in a coupled state K.

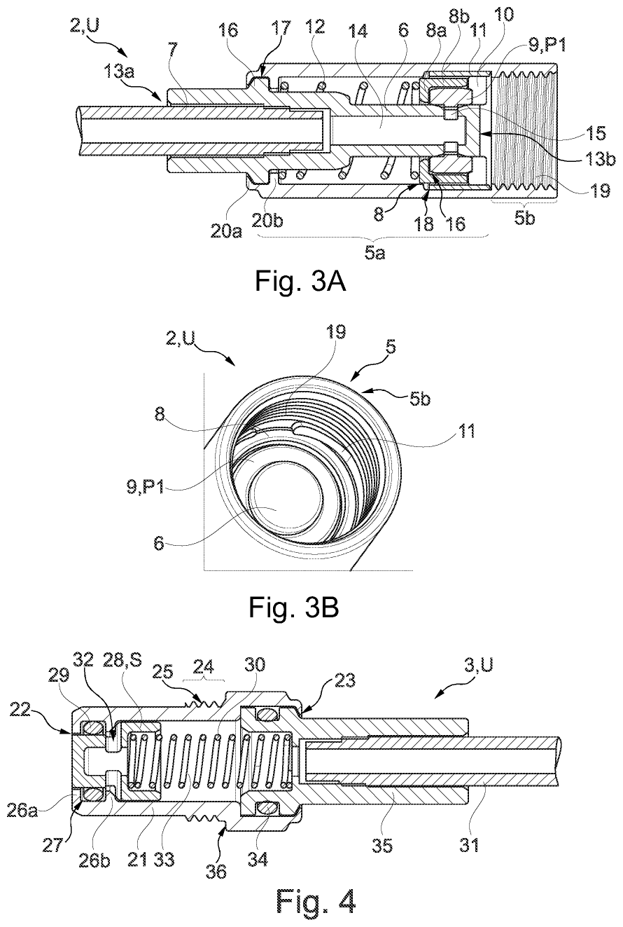

As can be seen from FIGS. 3A and 3B, the first coupling component 2 comprises a cylindrical coupling housing 5 which is open on both sides and has a receiving section 5a and a coupling section 5b. The first coupling component 2 comprises a cylindrical hydraulic chamber 6, a first hose section 7, a first bolt 8, a first sealing device 9, a sleeve 10 with a clip 11, and a first spring device 12.

The hydraulic chamber 6 is open at one axial end 13a and closed at another opposite end 13b. The first hose section 7 is inserted into the hydraulic chamber 6 through the open end 13a and is thus fluidically connected to it.

The hydraulic chamber 6 and the first hose section 7 are prefilled with a first hydraulic liquid 14. The first hose section 7 is closed at the end outside the hydraulic chamber 6 at an end not shown, so that the first hydraulic liquid 14 cannot escape through the first hose section 7.

The hydraulic chamber 6 has a first flow opening 15 in a portion adjacent to the closed end 13b. The first flow opening is formed as a partially radially circumferential opening in an outer surface of the hydraulic chamber 6.

The hydraulic chamber 6 and the hose section 7 inserted therein are received in sections in the receiving section 5a of the coupling housing 5. The hydraulic chamber 6 is attached to the coupling housing 5. For this purpose, a circumferential projection 16 on the outside of the hydraulic chamber 6 engages positively in a groove 17 of the coupling housing 5 formed between two circumferential lugs 20a, 20b.

The first bolt 8, the first sealing device 9, the sleeve 10 and the first spring device 12 are fully received in the receiving section 5a of the coupling housing 5.

The first bolt 8 is formed to be annular in shape in an axial plan view. It comprises a bolt face 8a and a peripheral rim 8b that projects axially from the bolt face 8a and encloses a receiving space 16 therewith. The first sealing device 9 is configured as a sealing ring and is received in the receiving space 16.

The first bolt 8 is elastically mounted on the first spring device 12, which is configured as a helical compression spring and which rotates around the hydraulic chamber 6. The first bolt 8 and the first sealing device 9 sit on the outside of the hydraulic chamber 6 and completely surround it.

The sleeve 10 is arranged concentrically with the first bolt and surrounds it in sections. The clip 11 of the sleeve 10 engages a receptacle 18 incorporated on an inner surface of the coupling housing 5. As a result, the sleeve 10 is secured in the coupling housing 5 in a form-fitting manner. The first spring device 12 presses the first piston 8 into the sleeve 10 in sections and holds it therein.

The first sealing device 9 is arranged in a first position P1 in which it seals off the first flow opening 15. For this purpose, the first sealing device 9 sits on the first flow opening 15 and completely surrounds it. The clip 11 of the sleeve 10 presses the first sealing device 9 radially against the first flow opening 15, thereby securing the flow-tight seal so that the first hydraulic liquid 14 cannot leak out and so that no air can enter the hydraulic chamber 6 from the outside and/or be trapped in the hydraulic liquid 14.

The coupling section 5b of the coupling housing 5 is unoccupied in the uncoupled state U of the two components 2, 3 according to FIGS. 1, 3A and 3B. The coupling section 5b has an internal thread 19 for coupling with the second component 3.

According to FIG. 4, the second component 3 comprises a hydraulic cylinder 21. The hydraulic cylinder 21 has an axial insertion opening 22 and an opposite adapter opening 23. The hydraulic cylinder 21 has a coupling mating section 24 in which an external thread 25 is arranged. Arranged immediately behind the insertion opening 22 are two circumferential ribs 26a, 26b which enclose a receiving groove 27 in the hydraulic cylinder 21 between them. A second hydraulic liquid 33 is received in the hydraulic cylinder 21.

The second component 3 comprises a second piston 28, a second sealing device 29 and a second spring device 30. Furthermore, the second component 3 comprises a second hose section 31.

The second hose section 31 is fluidically connected to the hydraulic cylinder 21. At an end not shown, the second hose section 31 is closed so that the second hydraulic liquid 33 cannot leak. Via an adapter piece 35 of the second component 3, the second hose section 31 is inserted into the adapter opening 23 and attached in a form-fitting manner to the hydraulic cylinder 21. A third sealing device 34 of the second component 3 seals the connection between the adapter opening 23 and the adapter piece 35.

The second piston 28 is formed to be circular in shape in an axial plan view. A second flow opening 32 is incorporated in the second piston 28. The second flow opening 32 is formed as a partially radially circumferential opening in the second piston 28.

In the uncoupled state U according to FIGS. 2, 4 and 5A, the second piston 28 closes the insertion opening 22 of the hydraulic cylinder in a form-fitting manner and assumes a closed position S. It is elastically mounted on the second spring device 30, which is configured as a helical compression spring, in the hydraulic cylinder 21 so that it is pressed into the insertion opening 22 and is held in the closed position S. The second sealing device 29 additionally seals the insertion opening 22 in a flow-tight manner.

FIGS. 5A to 5D show method steps regarding how the two components 2, 3 are transferred together from the uncoupled state U to the coupled state G and finally form the coupling unit 4 in which the components 2, 3 are fluidically connected.

As shown in FIGS. 5A and 5B, components 2, 3 are positioned axially with respect to one another in such a way that the coupling section 5b of the first component 2 and the insertion opening 22 of the second component 3 face each other. Subsequently, the components 2, 3 are fitted into each other in such a way that the hydraulic cylinder 21 is arranged in the coupling section 5b of the coupling housing 5 in sections.

According to FIGS. 5C and 5D, the hydraulic cylinder 21 is pushed further and further into the coupling housing 5. The two components 2, 3 are screwed together by means of the internal thread 19 and the external thread 25 and thus detachably fastened to one another. During the screwing process, the hydraulic cylinder 21 is pushed through the sleeve 10 and thereby presses the first piston 8 together with the first sealing device 9 out of the sleeve 10 against the spring force of the first spring device 12. This moves the first sealing device 9 out of the first position P1 so that it frees the first flow opening 15. According to FIG. 5D, the first sealing device 9 is now arranged in the second position P2.

While the hydraulic cylinder 21 is being pushed through the sleeve 10, the hydraulic chamber 6 enters the hydraulic cylinder 21 through the insertion opening 22 with its closed axial end 13 in front, thereby pushing the second piston 28 out of the closing position S in the insertion opening 22 against the spring force of the second spring device 30 and further into the hydraulic cylinder 21. The hydraulic chamber 6 is thereby arranged in the hydraulic cylinder 21 with the closed axial end 13b and with the portion in which the first flow opening 15 is incorporated.

When the two components are fully screwed together, the coupling unit 4 is formed. In that the first flow opening 15 is arranged together with the second flow opening 32 in the hydraulic cylinder 21, the flow connection between the hydraulic chamber 6 and the hydraulic cylinder 21, is formed. To the outside, the coupling unit 4 and/or the flow connection is/are sealed by the three sealing devices 9, 29 and 34.

When the coupling unit 4 is unscrewed, e.g., for maintenance purposes, and the two components 2, 3 are thereby decoupled, the first piston 8 is axially displaced back along the hydraulic chamber under spring force so that the first sealing device 9 is again arranged in the first position P1 and seals the first flow opening 15 again. At the same time, the second piston 28 is pushed back again axially in the hydraulic cylinder 21 under a spring force and arranged again in the insertion opening 22 so that it is closed by the second piston 28 and sealed by the second sealing device 29.

### LIST OF REFERENCE SYMBOLS

1 Coupling arrangement

2 First coupling component

3 Second coupling component

4 Coupling unit

5 Coupling housing

5a Receiving section

5b Coupling section

6 Hydraulic chamber

7 First hose section

8 First bolt

8a Bolt face

8b Rim

9 First sealing device

10 Sleeve

11 Clip

12 First spring device

13a Open axial end

13b Closed axial end

14 First hydraulic liquid

15 First flow opening

16 Receiving space

17 Groove

18 Receptacle

19 Internal thread

20a,b Lugs

21 Hydraulic cylinder

22 Axial insertion opening

23 Adapter opening

24 Coupling mating section

25 External thread

26a,b Ribs

27 Receiving groove

28 Second piston

29 Second sealing device

30 Second second spring device

31 Second hose section

32 Second flow opening

33 Second hydraulic liquid

34 Third sealing device

35 Adapter piece

K Coupled state

S Closed position

U Uncoupled state

1. A coupling arrangement for a hydraulic device, the coupling arrangement comprising:
a first coupling component and a second coupling component, the first coupling component and the second coupling component being transferable from an uncoupled state into a coupled state;
the first coupling component has a hydraulic chamber that is prefilled with a first hydraulic liquid, and the second coupling component has a hydraulic cylinder that is prefilled with a second hydraulic liquid;
the hydraulic chamber and the hydraulic cylinder are fluidically connected to one another in the coupled state of the first coupling component and the second coupling component;
a first flow opening is incorporated in the hydraulic chamber, and the first coupling component has a first sealing device; and
the first sealing device is configured to close the first flow opening in a flow-tight manner in the uncoupled state and frees the first flow opening in the coupled state for fluidic connection of the first coupling component to the second coupling component.

2. The coupling arrangement according to claim 1, wherein the hydraulic chamber is cylindrical and the first sealing device is a sealing ring, the first sealing device encloses the hydraulic chamber in the uncoupled state in a first position, and covers and seals the first flow opening in the first position, and the first sealing device encloses the hydraulic chamber in the coupled state in a second position, and the first flow opening is uncovered and free from the first sealing device in the second position.

3. The coupling arrangement according to claim 2, wherein the first coupling component has a first piston that is annular in shape in an axial plan view and surrounds the hydraulic chamber, the first piston has a receiving space, the first sealing device is arranged in the receiving space, and the first piston is axially displaceable along the hydraulic chamber so that the first sealing device is transferable from the first position to the second position.

4. The coupling arrangement according to claim 3, wherein the first coupling component comprises a sleeve which is arranged concentrically to at least one of the first piston or to the hydraulic chamber, the sleeve encloses the first piston at least in sections in at least one of the uncoupled state or the first position of the first sealing device.

5. The coupling arrangement according to claim 4, wherein the first coupling component comprises a first spring device, the first piston is elastically mounted on the first spring device, the first piston, in the uncoupled state, is pressed at least partially into the sleeve under spring force, the sleeve applies a radial pressure on the first piston and on the first sealing device so that the first sealing device is at least one of pressed onto the first flow opening or is secured against detachment from the first flow opening.

6. The coupling arrangement according to claim 5, wherein the second coupling component comprises a second piston and a second sealing device, the second piston is arranged to be axially movable in the hydraulic cylinder, the hydraulic cylinder has an axial insertion opening, and the insertion opening is closed in a form-fitting manner in the uncoupled state by the second piston and sealed in a flow-tight manner by the second sealing device.

7. The coupling arrangement according to claim 6, wherein the second coupling component comprises a second spring device, the second piston is elastically mounted on the second spring device, the second piston, in the uncoupled state, is pressed into the insertion opening under spring force and assumes a closed position.

8. The coupling arrangement according to claim 6, wherein, in the coupled state, a portion of the hydraulic chamber in which the first flow opening is incorporated protrudes through the insertion opening in the hydraulic cylinder so that the first flow opening is arranged inside the hydraulic cylinder.

9. The coupling arrangement according to claim 6, wherein the first coupling component has a cylindrical coupling housing with a receiving section and with a coupling section, the hydraulic chamber, the first spring device, and at least one of the first piston or the sleeve are received in the receiving section at least in sections, and the coupling section has an internal thread, the hydraulic cylinder of the second coupling component has a coupling mating section with an external thread, the internal thread and the external thread are positioned next to each other by inserting the hydraulic cylinder into the coupling housing for mutual screwing together.

10. A method for coupling and fluidically connecting a first coupling component and a second coupling component of the coupling arrangement according to claim 2, the method comprising inserting at least a part of the second coupling component into the first coupling component, and moving the first sealing device out of the first position, in which the first sealing device seals the first flow opening, during the inserting and thereby freeing the first flow opening to form the fluidic connection.

11. The coupling arrangement according to claim 4, wherein the first piston is moved away from the sleeve in the coupled state and is arranged spaced apart therefrom.

12. The coupling arrangement according to claim 7, wherein the second piston, in the coupled state, is displaced axially out of the closed position.

13. The coupling arrangement according to claim 9, wherein the first coupling component and the second coupling component are coupled by mutual screwing together of the internal thread and the external thread to form a coupling unit in which the hydraulic chamber and the hydraulic cylinder are fluidically connected to one another.

14. A coupling arrangement for a hydraulic device, the coupling arrangement comprising:
a first coupling component and a second coupling component that are movable from an uncoupled state into a coupled state;
the first coupling component has a first piston with a hydraulic chamber that is adapted to be prefilled with a first hydraulic liquid;
the second coupling component has a hydraulic cylinder that is adapted to be prefilled with a second hydraulic liquid, with a second piston that is movable in the hydraulic cylinder;
the hydraulic chamber includes a first flow opening defined in the first piston, and the first coupling component has a first seal that is configured to close the first flow opening in the uncoupled state and frees the first flow opening in the coupled state, and the first piston displaces the second piston for fluidic connection of the first flow opening to the hydraulic cylinder.

15. The coupling arrangement of claim 14, wherein the hydraulic chamber is cylindrical and the first seal is a sealing ring that encloses the hydraulic chamber in the uncoupled state in a first position, and covers and seals the first flow opening in the first position, and the first seal encloses the hydraulic chamber in the coupled state in a second position, and the first flow opening is uncovered and free from the first seal in the second position.

16. The coupling arrangement of claim 15, wherein the first piston is axially displaceable so that the first seal is transferable from the first position to the second position.

17. The coupling arrangement of claim 15, wherein the first coupling device further comprises a sleeve in which the first piston is axially displaceable, and a spring which exerts a spring force on the first piston, the first piston, in the uncoupled state, is pressed at least partially by the spring force into the sleeve, and the sleeve applies a radial pressure on the first piston and on the first sealing device so that the first sealing device is at least one of pressed onto the first flow opening or is secured against detachment from the first flow opening.

18. The coupling arrangement of claim 14, wherein the second coupling component further comprises a second seal, the hydraulic cylinder has an axial insertion opening, and the insertion opening is closed in a form-fitting manner in the uncoupled state by the second piston and sealed in a flow-tight manner by the second seal.

19. The coupling arrangement of claim 18, wherein the second coupling component further comprises a second spring that acts on the second piston with a spring force, and the second piston, in the uncoupled state, is pressed into the insertion opening by the spring force and assumes a closed position.

20. The coupling arrangement of claim 19, wherein in the coupled state, a portion of the first piston in which the first flow opening is incorporated protrudes through the insertion opening in the hydraulic cylinder so that the first flow opening is arranged inside the hydraulic cylinder.
